(19) United States
(12) Patent Application Publication
(10) Pub. No.: US 2025/0007100 A1
(43) Pub. Date: Jan. 2, 2025

(54) SECONDARY BATTERY

(71) Applicant: TOYOTA JIDOSHA KABUSHIKI KAISHA, Toyota-shi (JP)

(72) Inventors: Masahiro ISHIZUKA, Toyota-shi (JP); Kosuke SUZUKI, Toyota-shi (JP); Hideto MORI, Nisshin-shi (JP); Mitsuru TATEISHI, Toyota-shi (JP); Shinya ISHIKAWA, Toyota-shi (JP); Mari TARUTANI, Nagoya-shi (JP); Kenta KIMURA, Toyota-shi (JP)

(73) Assignee: TOYOTA JIDOSHA KABUSHIKI KAISHA, Toyota-shi (JP)

(21) Appl. No.: 18/679,572

(22) Filed: May 31, 2024

(30) Foreign Application Priority Data
Jun. 28, 2023 (JP) 2023-105674

(51) Int. Cl. H01M 50/474; H01M 50/103; H01M 50/14; H01M 50/15; H01M 50/48; H01M 50/531; H01M 50/548

(52) U.S. Cl. CPC H01M 50/474; H01M 50/103; H01M 50/14; H01M 50/15; H01M 50/48; H01M 50/531; H01M 50/548; H01M 2220/20

(57) ABSTRACT

A secondary battery includes an electrode assembly, a tubular member, a pair of sealing bodies, a first external terminal, a second external terminal, and a spacer disposed inside the tubular member, wherein the electrode assembly has a first end portion located on one side in a direction parallel to the cylindrical axis direction and a second end portion located on the other side in the parallel direction, and the first end portion is provided with one or more first current collector tabs electrically connected to the first external terminal, and the second end portion is provided with one or more second current collector tabs electrically connected to the second external terminal, and the spacer includes a first member provided between the one sealer and the first end portion, and a second member provided between the other sealer and the second end portion.

### CROSS-REFERENCE TO RELATED APPLICATION

This application claims priority to Japanese Patent Application No. 2023-105674 filed on Jun. 28, 2023, incorporated herein by reference in its entirety.

### BACKGROUND

### 1. Technical Field

The present disclosure relates to a secondary battery, and more particularly, to a secondary battery mounted on a vehicle.

### 2. Description of Related Art

As a related-art secondary battery, Japanese Unexamined Patent Application Publication No. 2021-044082 (JP 2021-044082 A) discloses a configuration in which an electrode assembly including a current collector tab at its upper end is housed in a case and a shock absorbing member is disposed between the electrode assembly and the case. The case includes a body that is open upward and a sealer that closes the opening of the body. The shock absorbing member has a bottomed tubular bag shape that is open upward, and is provided to surround the electrode assembly about an axis parallel to the vertical direction.

### SUMMARY

In recent years, there is a demand for secondary batteries having a low profile and a high capacity. In order to realize such a demand, it is conceivable to reduce the height of the electrode assembly and increase the horizontal length of the electrode assembly. In such a case, a configuration is conceivable in which the electrode assembly is housed in a tubular member that is open on both sides in a lateral direction and the openings of the tubular member on both sides in the lateral direction are closed by a pair of sealers provided with external terminals.

When the secondary battery is mounted on a vehicle or the like, the electrode assembly may move in the lateral direction (tube axis direction of the tubular member) due to vibration of the vehicle or the like. If no measures are taken in such a case, the current collector tab located on the opposite side to the moving direction of the electrode assembly is pulled. Therefore, the current collector tab may be damaged or the electrical connection between the current collector tab and the external terminal may be lost.

The present disclosure has been made in view of the above problems, and an object of the present disclosure is to provide a secondary battery in which the influence of an external force on a current collector tab can be suppressed.

A secondary battery according to the present disclosure includes: an electrode assembly;
a tubular member that houses the electrode assembly;
a pair of sealers that closes a pair of openings provided on both sides in a tube axis direction of the tubular member;
a first external terminal provided on one sealer out of the pair of sealers;
a second external terminal provided on the other sealer out of the pair of sealers; and
a spacer disposed inside the tubular member.

The electrode assembly includes a first end positioned on one side in a parallel direction that is parallel to the tube axis direction, and a second end positioned on the other side in the parallel direction.

The first end is provided with one or more first current collector tabs electrically connected to the first external terminal.

The second end is provided with one or more second current collector tabs electrically connected to the second external terminal.

The spacer includes a first member provided between the one sealer and the first end, and a second member provided between the other sealer and the second end.

In the above configuration, the spacer is disposed between both ends of the electrode assembly and the sealers. With the spacer, it is possible to exert a resistive force in the opposite direction against an external force that causes movement in a direction parallel to the tube axis direction. Accordingly, the movement of the electrode assembly can be suppressed and the pulling of one of the first current collector tab and the second current collector tab along with the movement of the electrode assembly can be suppressed. As a result, the influence of the external force on the current collector tab due to vibration or the like can be suppressed.

In the secondary battery according to the present disclosure, the spacer may have elasticity.

With the above configuration, an elastic force can be applied to the electrode assembly in addition to the resistive force. Accordingly, the movement of the electrode assembly can further be suppressed and the influence of the external force on the current collector tab due to vibration or the like can further be suppressed.

The secondary battery according to the present disclosure may further include:
a first conductive member including a first facing portion that faces the first end in the parallel direction, and connected to the first external terminal; and
a second conductive member including a second facing portion that faces the second end in the parallel direction, and connected to the second external terminal.

The one or more first current collector tabs may be connected to the first facing portion on a distal end side in a state in which the one or more first current collector tabs are folded in an intersecting direction that intersects the parallel direction to include portions that face each other in the parallel direction with a first clearance.

The one or more second current collector tabs may be connected to the second facing portion on a distal end side in a state in which the one or more second current collector tabs are folded in the intersecting direction to include portions that face each other in the parallel direction with a second clearance.

The first member may be disposed in the first clearance.

The second member may be disposed in the second clearance.

With the above configuration, when a pulling force is applied to one side of the first current collector tab and the second current collector tab in the moving direction of the electrode assembly along with the movement of the electrode assembly in the parallel direction that is parallel to the tube axis direction, a resistive force against the pulling force can be applied to a connecting portion by the spacer. The connecting portion is a portion of connection between the first current collector tab and the first facing portion or a portion of connection between the second current collector tab and the second facing portion. Thus, the influence of the external force on the current collector tab due to vibration or the like can be suppressed more suitably.

According to the present disclosure, it is possible to provide the secondary battery in which the influence of the external force on the current collector tab can be suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a secondary battery according to an embodiment;

FIG. 2 is an exploded perspective view of the secondary battery according to the embodiment;

FIG. 3 is a cross-sectional view of the secondary battery along III-III shown in FIG. 1;

FIG. 4 is a cross-sectional view of the secondary battery along IV-IV shown in FIG. 1; and

FIG. 5 is a cross-sectional view of the secondary battery taken along V-V shown in FIG. 3.

### DETAILED DESCRIPTION OF EMBODIMENTS

Hereinafter, embodiments of the present disclosure will be described in detail with reference to the drawings. In the following embodiments, the same or common parts are denoted by the same reference numerals in the drawings, and the description thereof will not be repeated.

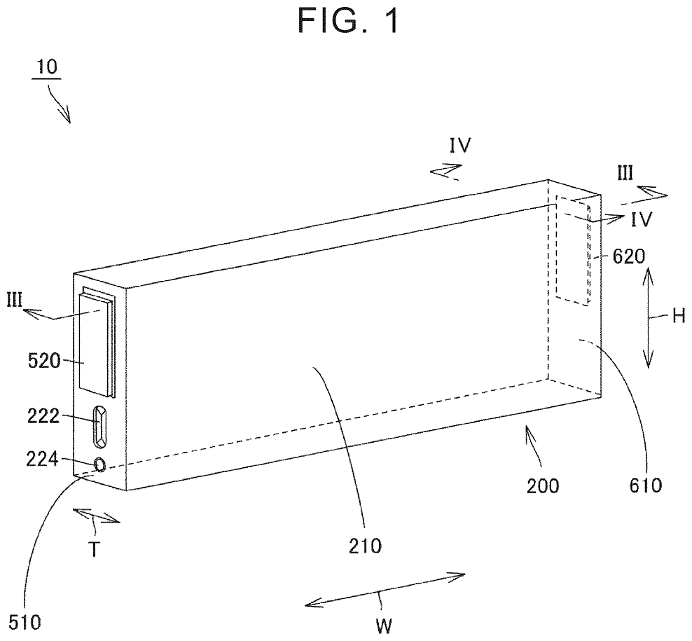

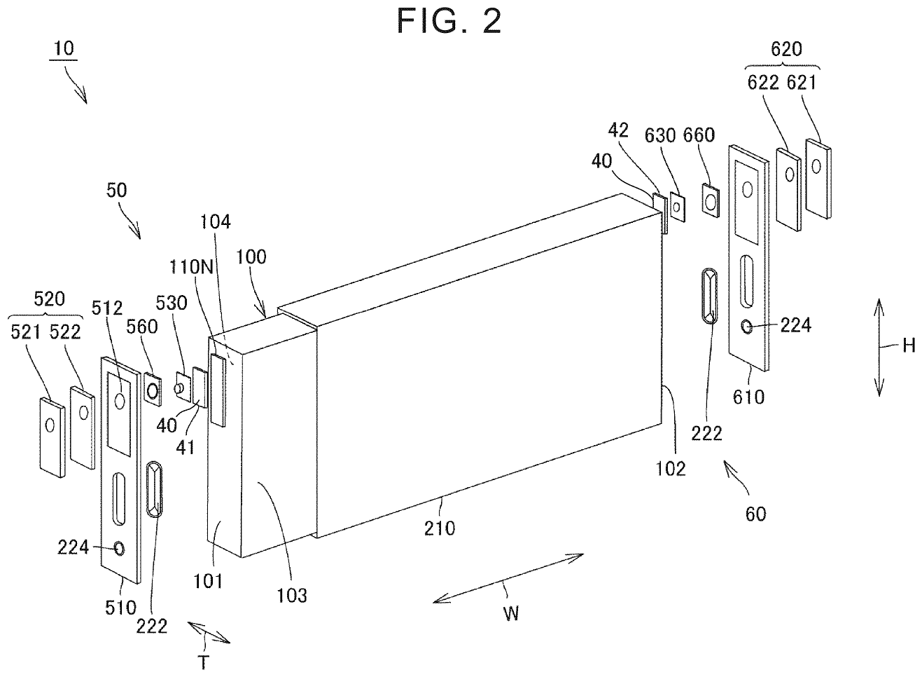

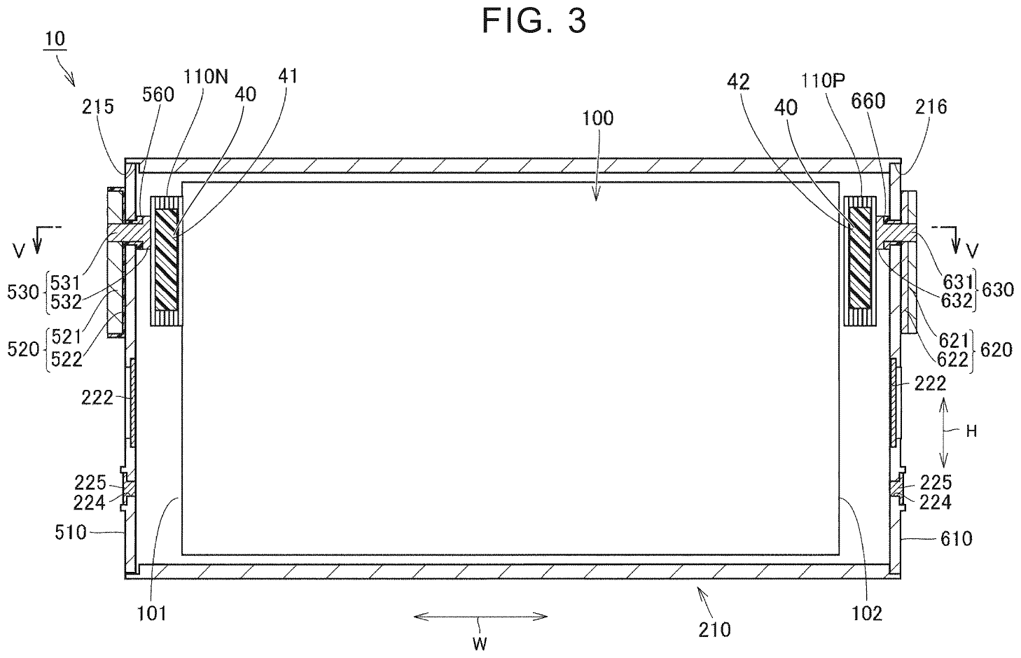

FIG. 1 is a perspective view of a secondary battery according to an embodiment. FIG. 2 is an exploded perspective view of the secondary battery according to the embodiment. FIG. 3 is a cross-sectional view of the secondary battery taken along III-III shown in FIG. 1. Referring to FIGS. 1 to 3, a secondary battery 10 according to an embodiment will be described.

As illustrated in FIGS. 1 to 3, the secondary battery 10 according to Embodiment 1 includes an electrode assembly 100, a housing 200, a negative electrode member 520 as one external terminal, a positive electrode member 620 as the other external terminal, and a spacer 40.

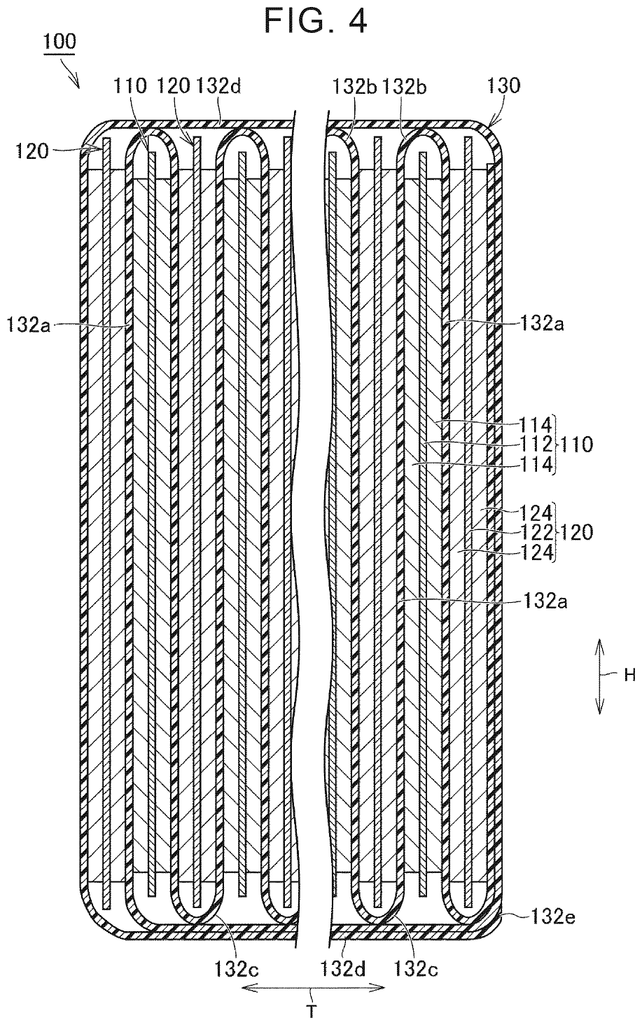

The electrode assembly 100 has a first end portion 101 located on one side in the width direction W of the housing 200 and a second end portion 102 located on the other side in the width direction W. The width direction W is a direction parallel to the cylindrical axis direction of the tubular member 210 described later. The first end portion 101 is provided with a plurality of negative electrode tab 110N as one or more first current collector tabs. The second end portion 102 is provided with a plurality of positive electrode tab 110P as one or more second current collector tabs. The negative electrode tab 110N and the positive electrode tab 110P may be singular. A detailed configuration of the electrode assembly 100 will be described later with reference to FIG. 4.

The housing 200 has a rectangular parallelepiped shape in which the thickness in the thickness direction T is smaller than the width in the width direction W and the height in the height direction H. The thickness direction T is parallel to a parallel direction in which a positive electrode 110 (see FIG. 4) and a negative electrode 120 (see FIG. 4), which will be described later, are arranged side by side. The width direction W is orthogonal to the thickness direction T. The height direction H is orthogonal to the thickness direction T and the height direction H. The width of the housing 200 in the width direction W is larger than the height of the housing 200 in the height direction H.

The housing 200 accommodates the electrode assembly 100 and an electrolytic solution (not shown) therein. The housing 200 includes a tubular member 210 for accommodating the electrode assembly 100, a first sealer 510 as a pair of sealing bodies, and a second sealer 610.

In the tubular member 210, a pair of openings are provided on both sides in the cylinder axial direction. The pair of openings includes a first opening 215 and a second opening 216. The first opening 215 is provided on one side in the width direction W, and the second opening 216 is provided on the other side in the width direction W. The tubular member 210 is made of a metal such as aluminum.

A spacer 40 is disposed inside the tubular member 210. The spacer 40 is formed of, for example, an insulating member. The spacer 40 may have elasticity. The spacer 40 includes a first member 41 and a second member 42 which will be described later. The spacer 40 (each of the first member 41 and the second member 42) may be made of polyethylene, polypropylene foam, styrene rubber, ethylene-propylene rubber, or the like. The first member 41 and the second member 42 may have, for example, a leaf spring shape.

The first sealer 510 closes the first opening 215. The first sealer 510 has a flat plate shape. The first sealer 510 is made of a metal such as aluminum. The first sealer 510 is fixed to the first opening 215 by, for example, laser welding or the like.

The second sealer 610 closes the second opening 216. The second sealer 610 has a flat plate shape. The second sealer 610 is made of a metal such as aluminum. The second sealer 610 is fixed to the second opening 216 by, for example, laser welding or the like.

Each of the first sealer 510 and the second sealer 610 is provided with a pressure release valve 222 and a liquid injection port 224. The pressure release valve 222 is provided so as to break when the internal pressure of the housing 200 becomes equal to or higher than a predetermined pressure. When the pressure release valve 222 is broken, the gas in the housing 200 is discharged to the outside of the housing 200, and thus the internal pressure in the housing 200 is lowered.

The liquid injection port 224 is sealed by a sealing member 225. The liquid injection port 224 is a through hole for injecting an electrolytic solution into the housing 200 in the manufacturing process of the secondary battery 10. The liquid injection port 224 is scaled by a sealing member 225. The sealing member 225 is a member that seals the liquid injection port 224 after the electrolytic solution is injected into the housing 200. The sealing member 225 may be, for example, a ventilation membrane that allows a gas to pass through without allowing a liquid to pass through. In this case, when the gas generated during charging is discharged to the outside of the housing 200, the gas can be discharged through the ventilation film. This eliminates the trouble of separately providing a gas vent. In addition, it is possible to prevent the electrolytic solution from leaking out of the housing 200 by the ventilation film. Note that the sealing member 225 is not limited to the ventilation film, and a resin member, a metal member, or the like can be appropriately employed.

The first sealer 510 is provided with a negative electrode member 520, and the second sealer 610 is provided with a positive electrode member 620.

The negative electrode member 520 is provided on the outer surface of the first sealer 510. The negative electrode member 520 functions as a negative electrode terminal. The negative electrode member 520 includes a negative electrode terminal plate 521 and an insulating plate 522.

The negative electrode terminal plate 521 is formed in a substantially rectangular parallelepiped shape. The negative electrode terminal plate 521 is held by an insulating plate 522. The insulating plate 522 is fixed to the outer surface of the first sealer 510. The insulating plate 522 insulates the first sealer 510 from the negative electrode terminal plate 521. Each of the negative electrode terminal plate 521 and the insulating plate 522 is provided with a through hole through which a first connecting portion 532 described later is inserted.

The positive electrode member 620 is provided on the outer surface of the second sealer 610. The positive electrode member 620 functions as a positive electrode terminal. The positive electrode member 620 includes a positive electrode terminal plate 621 and a terminal block 622.

The positive electrode terminal plate 621 is formed in a rectangular parallelepiped shape. The positive electrode terminal plate 621 is made of a metal such as aluminum.

The terminal block 622 is formed in a rectangular parallelepiped shape. The terminal block 622 is made of a metal (iron or the like) different from the metal constituting the positive electrode terminal plate 621. The terminal block 622 is fixed to the outer surface of the second sealer 610 by welding or the like. The positive electrode terminal plate 621 is fixed to the terminal block 622 by welding or the like. The tubular member 210 and the second sealer 610 are electrically connected to the positive electrode terminal plate 621 via the terminal block 622, and are charged to the same polarity as the positive electrode terminal plate 621. Each of the positive electrode terminal plate 621 and the terminal block 622 is formed with a through hole through which a second connecting portion 632 described later is inserted.

An insulating plate may be disposed between the positive electrode member 620 and the second sealer 610, and the positive electrode member 620 and the second sealer 610 may be electrically insulated from each other. In this case, an insulating plate may be disposed instead of the terminal block 622, or an insulating plate may be disposed between the terminal block 622 and the second sealer 610.

The secondary battery 10 further includes a first conductive member 530 and an insulator 560 on the negative electrode member 520 side.

The first conductive member 530 connects the plurality of negative electrode tab 110N and the negative electrode terminal plate 521. The plurality of negative electrode tabbing 110N are connected to the first conductive member 530 in a bundled manner by ultrasonic welding or the like. The first conductive member 530 includes, for example, a first facing portion 531 and a first connecting portion 532. The first facing portion 531 has a plate shape. The first facing portion 531 is substantially parallel to the inner surface of the first sealer 510. The first facing portion 531 faces the first end portion 101 of the electrode assembly 100 in the width direction W. The first connecting portion 532 extends along a direction parallel to the first direction. The first connecting portion 532 has, for example, a cylindrical shape. The distal end portion of the first connecting portion 532 passes through the first sealer 510, the insulating plate 522, and the negative electrode terminal plate 521, and is caulked to the negative electrode terminal plate 521.

The insulator 560 is disposed between the first facing portion 531 and the first sealer 510, and is insulated from the first facing portion 531 and the first sealer 510. The insulator 560 includes a portion covering the periphery of the proximal end side of the first connecting portion 532 and a portion located between the first facing portion 531 and the inner surface of the first sealer 510.

The negative electrode member 520, the first sealer 510, the first conductive member 530, and the insulator 560 are assembled to form the first lid assembly 50.

The first lid assembly 50 is fixed to the tubular member 210 by attaching the first sealer 510 to the first opening 215 while the plurality of negative electrode tabs 110N and the first conductive member 530 are fixed by welding or the like.

The secondary battery 10 further includes a second conductive member 630 and an insulator 660 on the positive electrode member 620 side.

The second conductive member 630 connects the plurality of positive electrode tabs 110P and the positive electrode terminal plate 621. The plurality of positive electrode tabbing 110P are connected to the second conductive member 630 in a bundled manner by ultrasonic welding or the like. The second conductive member 630 includes a second facing portion 631 and a second connecting portion 632. The second facing portion 631 has a plate shape. The second facing portion 631 is substantially parallel to the inner surface of the second sealer 610. The second facing portion 631 faces the second end portion 102 of the electrode assembly 100 in the width direction W. The second connecting portion 632 extends along a direction parallel to the first direction. The second connecting portion 632 has, for example, a cylindrical shape. The distal end portion of the second connecting portion 632 penetrates the second sealer 610, the terminal block 622, and the positive electrode terminal plate 621, and is caulked to the positive electrode terminal plate 621.

The insulator 660 is disposed between the second facing portion 631 and the second sealer 610, and is insulated from the second facing portion 631 and the second sealer 610. The insulator 660 includes a portion covering the periphery of the proximal end side of the second connecting portion 632 and a portion located between the second facing portion 631 and the inner surface of the second sealer 610.

The positive electrode member 620, the second sealer 610, the second conductive member 630, and the insulator 660 are assembled to form the second lid assembly 60.

The second lid assembly 60 is fixed to the tubular member 210 by attaching the second sealer 610 to the second opening 216 while the plurality of positive electrode tabs 110P and the second conductive member 630 are fixed by welding or the like.

FIG. 4 is a cross-sectional view of the secondary battery taken along IV-IV shown in FIG. 1. A detailed configuration of an electrode assembly of a secondary battery will be described with reference to FIG. 4. In FIG. 4, for the sake of convenience, the housing 200 of the secondary battery 10 is omitted, and only the electrode assembly 100 is illustrated. The electrode assembly 100 will be described in detail with reference to FIG. 4.

As illustrated in FIG. 4, the electrode assembly 100 includes a plurality of positive electrodes 110, a plurality of negative electrodes 120, and a separator 130. The plurality of positive electrodes 110 and the plurality of negative electrodes 120 are arranged alternately in the thickness direction T in a state of being insulated by the separator 130.

Each of the negative electrodes 120 is formed in a rectangular shape having a width direction W as a longitudinal direction and a height direction H as a short side. Each negative electrode 120 includes a negative electrode current collector foil 122 and a negative electrode active material layer 124 provided on both surfaces of the negative electrode current collector foil 122. As shown in FIG. 4, the negative electrode current collector foil 122 has a negative electrode tab 110N in which the negative electrode active material layers 124 are not provided. The negative electrode tab 110N protrudes toward one side in the width direction W.

Each of the positive electrodes 110 is formed in a rectangular shape having a width direction W as a longitudinal direction and a height direction H as a short side. Each positive electrode 110 includes a positive electrode collector foil 112 and a positive electrode active material layer 114 provided on both surfaces of the positive electrode collector foil 112 in the thickness direction T. The positive electrode collector foil 112 has a positive electrode tab 110P in which the positive electrode active material layers 114 are not provided. The positive electrode tab 110P protrudes toward the other side in the width direction W.

The separator 130 insulates the positive electrode 110 from the negative electrode 120. The separator 130 is made of an insulating material and has minute voids that allow transmission of ions. The separator 130 is formed in a zigzag shape.

The separator 130 has a rectangular shape before being formed into a zigzag-fold shape. The separator 130 is disposed while being formed in a zigzag shape between the positive electrode 110 and the negative electrode 120. The separators 130 have a plurality of intervening portions 132a, a plurality of first folded portions 132b, a plurality of second folded portions 132c, and an outermost covering portion 132d.

The intervening portions 132a are interposed between the positive electrode 110 and the negative electrode 120 adjacent to each other in the thickness direction T. That is, the intervening portions 132a have a function of insulating the positive electrode 110 and the negative electrode 120 from each other. The intervening portions 132a are formed of rectangular regions.

The first folded portions 132b connect one end portions in the height direction H of the intervening portions 132a adjacent to each other in the thickness direction T so that the positive electrode 110 is positioned therebetween. The first folded portion 132b is disposed on one side (upper side) of the positive electrode 110 in the height direction H.

The second folded portions 132c connect the other end portions in the height direction H of the intervening portions 132a adjacent to each other in the thickness direction T so that the negative electrode 120 is positioned therebetween. The second folded portion 132c is disposed on the other side (lower side) of the negative electrode 120 in the height direction H.

The outermost covering portion 132d collectively covers the first folded portion 132b and the second folded portion 132c. More specifically, the outermost covering portion 132d covers all of the positive electrodes 110, all of the negative electrodes 120, all of the intervening portions 132a, all of the first folded portions 132b, and all of the second folded portions 132c together while being wound around a central axis parallel to the width direction W. The terminal 132e of the outermost covering portion 132d is set so as not to overlap with the positive electrode active material layer 114 and the negative electrode active material layer 124 in the thickness direction T. In the present embodiment, the terminal 132c of the outermost covering portion 132d is provided below the respective positive electrodes 110 and the respective negative electrodes 120. An insulating film (not shown) may be coated on a peripheral surface and a bottom surface of the plurality of positive electrodes 110, the plurality of negative electrodes 120, and the separator 130.

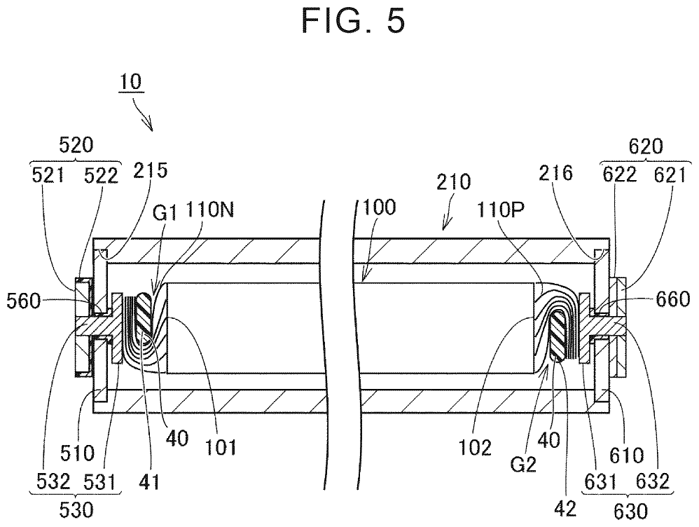

FIG. 5 is a cross-sectional view of the secondary battery taken along V-V shown in FIG. 3. Referring to FIG. 5, the connecting modes of the first member 41 and the second member 42 constituting the spacer 40 and the plurality of negative electrode tab 110N and the plurality of positive electrode tab 110P will be described.

The plurality of negative electrode tabs 110N are folded back in a direction intersecting the width direction W so as to include a part facing the width direction W with the first gap G1 therebetween, and the distal end portion side is connected to the first facing portion 531. Note that the distal end portion side of the negative electrode tab 110N is opposite to the side where the first end portion 101 is located. The plurality of negative electrode tabbing 110N are folded back in a substantially U-shape.

The plurality of positive electrode tabs 110P are folded back in a direction intersecting the width direction W so as to include a part facing the width direction W with the second gap G2 therebetween, and the distal end portion side is connected to the second facing portion 631. The distal end portion side of the positive electrode tab 110P is opposite to the side where the second end portion 102 is located. The plurality of positive electrode tabbing 110P are folded back in a substantially U-shape.

The first member 41 is disposed between the first sealer 510 and the first end portion 101 of the electrode assembly 100. Specifically, it is disposed in the first gap G1. The second member 42 is disposed between the second sealer 610 and the second end portion 102 of the electrode assembly 100. Specifically, it is disposed in the second gap G2.

As described above, since the first member 41 and the second member 42 are provided as the spacer 40, when an external force is applied to the electrode assembly 100 due to vibration or the like, the first member 41 or the second member 42 can exert a drag force in the direction opposite to the moving direction of the electrode assembly 100. The external force is moved in a direction parallel to the cylinder axial direction (width direction W), but is an external force. Accordingly, the movement of the electrode assembly 100 can be suppressed, and one of the negative electrode tab 110N and the positive electrode tab 110P can be suppressed from being pulled along with the movement of the electrode assembly 100. As a result, the influence of the external force on the electrode assembly 100 due to vibration or the like can be suppressed.

Further, since the first member 41 and the second member 42 have elasticity, an elastic force can be applied to the electrode assembly 100 in addition to the above-described drag force. Accordingly, the movement of the electrode assembly 100 can be further suppressed, and the influence of the external force on the current collector tab due to vibration or the like can be further suppressed.

In addition, since the first member 41 and the second member 42 are disposed in the first gap G1 and the second gap G2, respectively, as described above, when a tensile force acts due to vibration or the like, the first member 41 and the second member 42 can exert a drag force against the tensile force on the connecting portion. The tension is a tension generated on one side of the negative electrode tab 110N and the positive electrode tab 110P in the moving direction of the electrode assembly 100. The connecting portion is a connecting portion between the negative electrode tab 110N and the first facing portion 531 or a connecting portion between the positive electrode tab 110P and the second facing portion 631. Thus, the influence of the external force on the current collector tab due to vibration or the like can be suppressed more suitably.

The embodiments disclosed herein are illustrative and not restrictive in all respects. The scope of the present disclosure is defined by the claims, and includes all modifications within the meaning and range equivalent to the claims.

What is claimed is:

1. A secondary battery comprising:
an electrode assembly;
a tubular member that houses the electrode assembly;
a pair of sealers that closes a pair of openings provided on both sides in a tube axis direction of the tubular member;
a first external terminal provided on one sealer out of the pair of sealers;
a second external terminal provided on another sealer out of the pair of sealers; and
a spacer disposed inside the tubular member, wherein:
the electrode assembly includes a first end positioned on one side in a parallel direction that is parallel to the tube axis direction, and a second end positioned on another side in the parallel direction;
the first end is provided with one or more first current collector tabs electrically connected to the first external terminal;
the second end is provided with one or more second current collector tabs electrically connected to the second external terminal; and
the spacer includes a first member provided between the one sealer and the first end, and a second member provided between the other sealer and the second end.

2. The secondary battery according to claim 1, wherein the spacer has elasticity.

3. The secondary battery according to claim 1, further comprising:
a first conductive member including a first facing portion that faces the first end in the parallel direction, and connected to the first external terminal; and
a second conductive member including a second facing portion that faces the second end in the parallel direction, and connected to the second external terminal, wherein:
the one or more first current collector tabs are connected to the first facing portion on a distal end side in a state in which the one or more first current collector tabs are folded in an intersecting direction that intersects the parallel direction to include portions that face each other in the parallel direction with a first clearance;
the one or more second current collector tabs are connected to the second facing portion on a distal end side in a state in which the one or more second current collector tabs are folded in the intersecting direction to include portions that face each other in the parallel direction with a second clearance;
the first member is disposed in the first clearance; and
the second member is disposed in the second clearance.
